(19) United States
(12) Patent Application Publication
(10) Pub. No.: US 2003/0054969 A1
(43) Pub. Date: Mar. 20, 2003

(54) Detergent compositions

(76) Inventors: Eugenio Fumagalli, Bergamo (IT); Maria Gabriella Coccia, Bergamo (IT); Massimo Magnoni, Bergamo (IT)

Correspondence Address: BIRCH STEWART KOLASCH & BIRCH, PO BOX 747, FALLS CHURCH, VA, 22040-0747, US

(21) Appl. No.: 10/131,196

(22) Filed: Apr. 25, 2002

(30) Foreign Application Priority Data
Apr. 27, 2001 (IT) MI2001A000884

(51) Int. Cl. C11D 3/00

(52) U.S. Cl. 510/394

(57) ABSTRACT

Detergent compositions for washing fabrics, particularly compositions for washing fabrics at low temperatures containing stilbene-triazine based optical brighteners.

The present invention relates to detergent compositions for washing fabrics. In particular it relates to compositions for washing fabrics at low temperatures containing stilbene-triazine-based optical brighteners.

### BACKGROUND OF THE INVENTION

Preparations designed for washing fabrics, in the form of clothing or other forms, are complex mixtures containing a variety of ingredients, each of which performs a specific function. These ingredients are surfactants, anti-redeposition agents which prevent soil from resettling after being dispersed by the surfactants, enzymes, substances able to develop active oxygen such as perborates, activators of the said substances, inorganic salts in the form of builders, sequestering agents, etc., and in most cases, optical brighteners.

Optical brighteners are used to give the fabrics washed a high degree of whiteness with shades pleasing to the human eye, which cannot be achieved merely by using surfactants and chemical bleachers.

Optical brighteners are fluorescent substances which act by re-emitting part of the UV radiation absorbed at a wavelength of 350-360 nm in the form of light visible to the human eye, mainly at a wavelength of 400-450 nm.

This radiation corresponds to the blue area of the visible spectrum, and therefore corrects the yellowish background colour which would remain after washing with detergents not containing optical brighteners because blue is complementary to it. The resulting overall effect is a bright white colour.

A further purpose of the use of optical brighteners is to give the detergent a greater degree of whiteness.

The efficacy of the action performed by optical brighteners in whitening both the fabric and the detergent depends on their chemical structure, the washing conditions and the composition of the detergent.

The optical brighteners most commonly used are the substantive type for cellulose fibres, which mainly belong to the chemical class of stilbene-triazine derivatives of general formula:

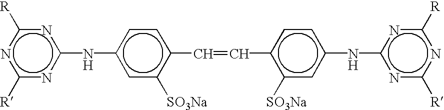

wherein R is a residue of formula:

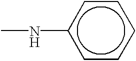

and R′ is a residue of formula —N(X)(X′) wherein X and X′, which can be the same or different, represent hydrogen, methyl, ethyl, a group with the formula —CH₂—CH₂OH or, taken together with the nitrogen atom to which they are bonded, form a morpholine ring. The most common compounds are those in which the group of formula —N(X)(X′) is a monoethanolamine, methylethanolamine, dimethylamine, ethylamine or morpholine residue.

The compound in which R′ is a morpholine residue (Registry number 16090-02-1) is the most common in practice.

Distyryl derivatives with the following formula are also used:

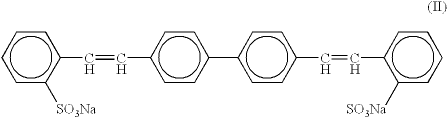

Numerous patents protect detergent formulations containing optical brighteners, in particular the morpholine derivative referred to above. The following Chemical Abstract references are quoted by way of example: 132 238754t, 127 294975z, 127 236019e, 125 25150y, 125 171563q, 124 149266c, 122 58882t, 121 38089r, 119 75116b, 96 21648q, 87 5404n, 86 142006f, 77 116389c.

The preference for the morpholine derivative is based not only on its toxicological characteristics but on its excellent performance in brightening the cellulose fibres in relation to its cost and the washing conditions. It has, in fact, a high affinity for cellulose fibres at temperatures between 40 and 60° C., namely those at which washing machine cycles are usually performed. The other stilbene-triazine derivatives of formula (I) mentioned above and the distyryl derivatives of formula (II) are not equally efficient at those temperatures, but may be more efficient at low temperatures. This difference is due to the fact that these optical brighteners are more soluble than the morpholine derivative at low temperatures; however, the advantage is lost when washing is performed at temperatures equal to or greater than 40° C. because the affinity for the cellulose substrate of the above-mentioned optical brighteners other than morpholine declines as the temperature increases.

The morpholine derivative identified by Registry Number 16090-02-1 is known to exist in two crystalline forms, named alpha and beta. The beta form is characterised by well-shaped, practically colourless crystals, and the alpha form by an amorphous form or yellow-green crystals with an indefinite structure.

The colourless (beta) form is preferred for use in detergents, as it contributes to the increase in the degree of whiteness of the detergent, whereas the alpha form induces a yellowish colour in the detergent.

See the following Chemical Abstract references in this respect: 96 87457h, 96 69047v, 93 206520y, 92 199759g, 89 7602u, 86 157056w, 86 142006f, 85 22782p, 80 49273g, 79 67827z, 77 103342g, 77 21589d, 72 122931m, 72 33252y, 68 115712e, 68 50079.

Attempts to improve the efficiency of the morpholine optical brightener are disclosed in DE 2.811.717 (C.A. 92 43280), DE 2.033.437 (C.A. 74 88957), JP 70 03.673 (C.A. 72 122931) and DE 1.904.854 (C.A. 72 115711), in which the size of the crystals of the beta crystalline form is reduced to increase their solubility and therefore their performance at low temperatures.

### SUMMARY OF INVENTION

It has surprisingly been found that the yellow-green form of the morpholine compound of formula (I) (R=NH-phenyl and R′=morpholinyl) is equally effective at temperatures as low as 0° C. and at temperatures above 60° C., with no need to grind the crystals, and also markedly improves the degree of whiteness of the detergent to a greater extent than the beta form or the distyryl derivatives, provided that the detergent formula contains not less than 1% of non-ionic alkoxylated surfactants.

The present invention thus relates to detergent compositions containing the optical brightener of formula (I), wherein R is as defined above and R′ represents the morpholine residue (RN=16090-02-1) in the yellow-green alpha form, characterised by the presence of not less than 1% by weight of non-ionic alkoxylated surfactants. The optical brightener used in accordance with the invention may be present in powder or granule form.

### DETAILED DESCRIPTION OF THE INVENTION

The solid detergent compositions of the invention may be in the form of powder, granule, pearl, pastille or tablet form, and may be obtained by spray-drying, dry-mixing, post-addition or mixed techniques. The morpholine optical brightener of formula:

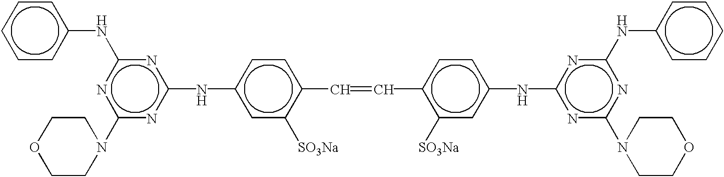

in the yellow-green alpha form (which is considered substantially amorphous by some Authors and microcrystalline by others) has a dissolution rate of over 90% of its own weight in two minutes at the temperature of 25° C., measured by the procedures indicated in comparative example no. 1 below. The optical brightener is present in the compositions of the invention in the proportion of 0.01 to 3% on the weight of the detergent composition, and preferably 0.1 to 0.2% by weight.

Any ethoxylated, propoxylated or ethopropoxylated linear- or branched-chain surfactant can be used as a non-ionic alkoxylated surfactant, such as:

alkylphenols, preferably octyl- or nonylphenols ethoxylated with 1 to 25 moles of ethylene oxide

linear- or branched-chain C₆-C₂₂ fatty acids ethoxylated, propoxylated or ethopropoxylated with 1 to 40 moles of ethylene or propylene oxides or a mixture thereof

linear- or branched-chain C₆-C₂₂ fatty acids and their amides ethoxylated with 1 to 40 moles of ethylene or propylene oxides or a mixture thereof

linear- or branched-chain C₆-C₂₂ fatty amines ethoxylated, propoxylated or ethopropoxylated with 1 to 40 moles of ethylene or propylene oxides or a mixture thereof.

These alkoxylated surfactants are present in quantities exceeding 1% by weight, preferably exceeding 3%, and even more preferably in proportions of between 4 and 10% by weight.

The detergent compositions of the invention may also contain:

Sulphated or Sulphonated Anionic Surfactants such as:

Alkyl or alkenyl sulphates of formula R—O—SO₃⁻M⁺, wherein R may have 10 to 22 carbon atoms and M is an alkaline metal, ammonium or alkanol ammonium cation.

Alkyl or alkenyl sulphates of formula R—O—(CH₂—CH₂—O)n—SO₃⁻M⁺, wherein R may have 10 to 22 carbon atoms, M is an alkaline metal, ammonium or alkanol ammonium cation, and n may have a value of 1 to 25.

Ethoxylated and sulphated alkyl phenols.

Alkyl polysaccharides and alkyl polyglycosides sulphates.

Sulphonated alkylbenzenes.

Primary or secondary C₆-C₂₄ alkanesulphonates.

Sulphonated C₆-C₂₄ olefins.

Sulphosuccinates and alkyl sulphosuccinates.

Amides of fatty acids with taurine and methyl taurine wherein the sulphonic groups are generally salified with alkaline metal, ammonium or alkanol ammonium cations.

Carboxylated Anionic Surfactants such as:

Soaps, with the carboxyl group in the primary or secondary position.

Alkyl ethoxy or polyethoxy carboxylates of general formula RO(CH₂CH₂O)xCH₂COOM, wherein M is an alkaline metal, ammonium or alkanol ammonium cation.

Sarcosinates of general formula R—CON(R₁)CH₂—COOM, wherein M is an alkaline metal, ammonium or alkanol ammonium cation.

Amphoteric Surfactants

Suitable amphoteric surfactants are:

amine oxides of general formula R₁—N(O)(R₂)₂, wherein R₁ represents an alkyl or arylalkyl group optionally containing functional groups such as hydroxyls, amides or the oxygen heteroatom, and R₂ represents C₁-C₃ alkyl.

Cationic Surfactants

Small amounts of cationic surfactants comprised in the general formula:

R₁R₂R₃R₄N⁺X⁻

wherein R₁ and R₂ are C₁-C₄ alkyl groups, R₃ is a C₆-C₁₈ alkyl or alkenyl group, R₄ is a C₂-C₈ alkyl, alkenyl or hydroxyalkyl group, and X is an anion such as Cl⁻, SO₄⁻, NO₃⁻ etc., may be present.

Builders

Builders may be soluble or insoluble in water. Examples of soluble builders are:

tripolyphosphates in the form of their alkaline metal salts; sodium, ammonium or potassium pyrophosphate; mono- or polycarboxylated substances in the form of their alkaline salts such as lactic acid, glycolic acid, tartaric acid, citric acid and succinic acid; and sodium borate.

Examples of substantially insoluble builders are zeolites based on natural and synthetic aluminosilicates, such as those known as Zeolite A, B, P, X, HS, MAP or mixtures thereof.

Alkalinising Agents

Alkalinising agents are used in detergents to provide the optimum pH at which the detergent action is best performed.

Carbonates, bicarbonates, hydroxides and silicates in the form of their alkaline or alkaline-earth salts are typically used, alone or in mixtures.

Sequestering Agents

Heavy metal sequestering agents may be organic phosphonates, e.g. alkaline salts of amino-alkylene-poly(alkylene phosphonates) such as diethylenetriamine-penta-(methylenephosphonate), ethylenediamine-tri(methylenephosphonate), hexamethylenediamine-tetra(methylene phosphonate); nitryl trimethylenephosphonate; nitrilotriacetic acid; ethylenediamine tetraacetic acid, or mixtures thereof.

Chemical Bleachers

Typical chemical bleachers are percarbonates, perborates, perphosphates, peracetic acid, perbenzoic acid, diperoxydodecanoic, tetradecanoic and hexadecanoic acids. Peracetic acid is particularly preferred. Peracetic acid can be generated in situ from its precursors such as tetra-acetyl ethylenediamine (TAED) or other activators, and from inorganic peroxides such as sodium perborate, percarbonate, persulphate, perphosphate or persilicate.

Enzymes

The detergents of the invention may contain enzymes. These enzymes include lipases, cellulases, peroxidases, proteases, amylases and glucoamylases, esterases, pectinases, reductases, oxygenases and lipoxygenases, alone or in mixtures. The enzymes may be stabilised by being incorporated in detergents by encapsulation or other methods.

Organic Polymer Compounds

Polymer compounds are generally added to promote dispersion and maintain the various ingredients in suspension, or with a soil anti-redeposition function. Polymers suitable for these purposes are acrylic acid homopolymers; acrylic acid copolymers, especially with maleic anhydride or acid, vinyl alcohol, vinyl acetate and aspartic acid; polyaspartic acids; polyvinylpyrrolidone; carboxymethyl cellulose; methyl cellulose; hydroxypropyl methylcellulose; ethyl hydroxyethyl cellulose; hydroxyethyl cellulose; polymers of ethylene oxide, propylene oxide and their copolymers. Polymers containing carboxyl groups are generally salified with sodium or potassium cations.

Antifoaming Agents

Anti-foaming agents may be added to detergent formulations in order to reduce foaming, especially for use in washing machines. Mixtures of silicones, preferably siloxanes, long-chain fatty acid triglycerides, esters of fatty acids with monovalent alcohols, and phosphoric acid esters such as tri-isobutyl phosphate, are used as antifoaming agents.

The detergent compositions of the invention may also contain “Soil Releasing Agents” (SRAs). SRAs are substances, generally oligomers, whose molecular structure contains hydrophilic or hydrophobic fragments able to adhere to synthetic fabrics such as nylon and terital with their hydrophobic parts to help detach any soil which may adhere to those fabrics during the rinsing cycles. Examples of SRAs are oligomeric polyesters of terephthalic acid with ethylene/propylene oxide polymers or their modifications containing sulphonic groups.

Other optional ingredients in detergent compositions are excipients such as sodium sulphate, colouring agents and perfumes.

### EXAMPLES

### Example 1

Determination of the dissolution rate at 25° C. of the morpholine optical brightener in the yellow-green (microcrystalline or amorphous) alpha form compared with the same agent in finely ground crystalline beta form with a mean particle diameter of 3μ.

The dissolution rate was expressed as the time required to solubilise 95% of the optical brightener (T 95).

The test was carried out by measuring with a spectrophotometer at the wavelength of 355 nm the specific extinction, over a period of time, of a suspension of optical brightener in a 5 g/l solution of standard sodium dodecylbenzene sulphonate-based detergent, buffered to pH 10±0.05 and thermostated to 25° C. The extinction was measured on an aliquot of solution filtered through a 0.45μ filter to remove the undissolved fraction. The measured extinction was compared with that of a sample completely dissolved by boiling for a lengthy time, and expressed as a percentage of optical brightener in solution.

The times taken to reach 95% of the maximum solubility (T 95) were as follows:

| Morpholine optical brightener | T 95 |
|---|---|
| Yellow-green microcrystalline/amorphous form | 1 min. 45 sec. |
| White crystalline (beta) form | 10 min. 30 sec. |

### Example 2

Three detergent formulations with the following compositions were prepared:

| | Detergent | Detergent | Detergent |
|---|---|---|---|
| Composition | no. 1 | no. 2 | no. 3 |
| Carboxymethyl cellulose | 1 | 1 | 1 |
| Sodium alkyl benzene sulphonate | 8 | 8 | 8 |
| C12-15 Pareth 7 | 8 | 4 | 0 |
| (ethoxylated alchohol) | | | |
| Sodium disilicate | 4 | 4 | 4 |
| Acrylic/maleic copolymer | 2 | 2 | 2 |
| Zeolite A | 30 | 30 | 30 |
| Sodium carbonate | 10 | 10 | 10 |
| Sodium soap | 6 | 6 | 6 |
| Sodium perborate | 15 | 15 | 15 |
| TAED | 3 | 3 | 3 |
| Na₂SO₄ | 7 | 10 | 13 |
| Water | 6 | 7 | 8 |

100 g of each detergents were added with 0.15% on the weight of the detergent composition, of the morpholine optical brightener of the invention in the yellow-green alpha form, or with 0.15% of the same morpholine optical brightener in the white crystalline beta form with a mean particle diameter of 3μ.

Table 1 shows the degree of whiteness of each of the three detergent compositions without optical brighteners by comparison with those of the same compositions to which optical brighteners were added. The degree of whiteness was measured with an Elrepho 2000 spectrophotometer and expressed in accordance with the Ganz formula after a 24-hour conditioning period at 40° C.:

W=3B-1,5G-0,5A

TABLE 1

| | Detergent | Detergent | Detergent |
|---|---|---|---|
| | no. 1 | no. 2 | no. 3 |
| Without optical brighteners | −21 | 15 | 27 |
| With optical brightener in yellow- | 86 | 78 | 38 |
| green form | | | |
| With optical brightener in white | 78 | 65 | 35 |
| crystalline form | | | |

### Example 3

A detergent formulation with the following percentage composition by weight was prepared:

| Composition | % |
|---|---|
| Carboxymethylcellulose | 1.2 |
| Sodium alkyl benzene sulphonate | 6.9 |
| C16-18 Pareth 14 (ethoxylated | 4 |
| alcohol) | 7.5 |
| Sodium silicate | 43.8 |
| Sodium tripolyphosphate | 1.9 |
| Magnesium silicate | 3.5 |
| Sodium soap | 21.2 |
| Na₂SO₄ | 0.2 |
| EDTA sodium salt | 9.8 |
| Water | |

0.3 g each of granules of the morpholine optical brightener of the invention in the yellow-green amorphous/microcrystalline form (Example 3A), the morpholine optical brightener in the white crystalline (beta) form (example 3B) and the optical brightener of formula (II) (example 3C) were added to three 100 g portions of the detergent composition described above.

Table 2 shows the degree of whiteness of the detergent composition without optical brighteners compared with the same composition with optical brighteners. The degree of whiteness was measured as described in example no. 2.

TABLE 2

| Detergent without | | | |
|---|---|---|---|
| optical brighteners | 3A | 3B | 3C |
| 71 | 140 | 78 | 75 |

### Example 4

The detergent composition of example 3 was added with 0.15% (on the composition weight) of the yellow-green morpholine optical brightener of the invention, having a specific extinction of 441 (sample 4A). Samples of detergents containing equivalent amounts of morpholine optical brightener in the white crystalline (beta) form with a mean particle diameter of 3μ (sample 4B), optical brightener with formula (II) (sample 4C) and optical brightener with formula (I) wherein X=H and X′=—C₂H5 (sample 4D), were prepared in the same way.

“Equivalent amounts” means parts by weight having the same extinction measured at 355 nm.

Washing cycles were performed at 5° C., 15° C. and 40° C. with the four samples of detergent obtained, on cotton not containing optical brighteners (EMPA 211), in accordance with the following procedure:

equipment: Linitest

water hardness: 25° F.

bath ratio: 1:10

duration of washing cycle: 15 minutes

rinses: 3, with bath ratio of 1:50.

The degree of whiteness was measured on the samples, after drying, with an Elrepho 2000 apparatus, and expressed in accordance with the Ganz formula.

The results are set out in Table 3.

TABLE 3

| | No. of | Detergent | Detergent | Detergent | Detergent |
|---|---|---|---|---|---|
| Washing T° | cycles | 4A | 4B | 4C | 4D |
| 5° C. | 1 | 110 | 82 | 100 | 90 |
| 5° C. | 3 | 143 | 114 | 140 | 125 |
| 15° C. | 1 | 149 | 120 | 138 | 127 |
| 15° C. | 3 | 180 | 164 | 172 | 160 |
| 40° C. | 1 | 152 | 141 | 135 | 133 |
| 40° C. | 3 | 180 | 177 | 160 | 155 |

1. A detergent composition for washing at high and low temperatures, comprising:
(a) 0.01% to 3% by weight of optical brightener of formula: 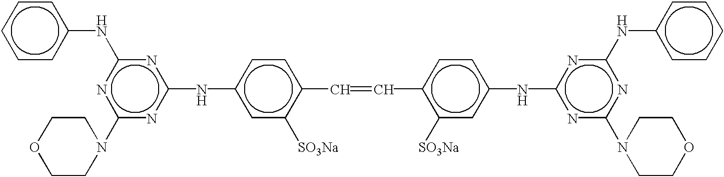
in the yellow-green alpha form, and
(b) at least 1% of non-ionic alkoxylated surfactants.

2. Composition as claimed in claim 1, in which the non-ionic alkoxylated surfactants are non-ionic ethoxylated surfactants.

3. Composition as claimed in claim 2, in which the non-ionic ethoxylated surfactants are linear- or branched-chain ethoxylated fatty alcohols.

4. Composition as claimed in claim 3, in which the alcohols have a chain length of C12 to C18 and the ethoxyl chain comprises 6 to 25 monomer units.

5. Composition as claimed in any one of claims 1 to 4, in which the quantity of ethoxylated alcohols is at least 3% on weight of the detergent composition.

6. Composition as claimed in any one of claims 1 to 5, in which the optical brightener is compacted in the form of granules.

7. Composition as claimed in any one of claims 1 to 6, in which the optical brightener is present in the amount of 0.1 to 0.2% by weight.
